(19) United States
(12) Patent Application Publication
(10) Pub. No.: US 2013/0277996 A1
(43) Pub. Date: Oct. 24, 2013

(54) MANHOLE TUBE HOLDER

(71) Applicant: Anthony Jerome Middleton, Austin, TX (US)

(72) Inventor: Anthony Jerome Middleton, Austin, TX (US)

(21) Appl. No.: 13/866,993

(22) Filed: Apr. 19, 2013

Related U.S. Application Data
(60) Provisional application No. 61/635,657, filed on Apr. 19, 2012.

(51) Int. Cl. F16B 2/02

(52) U.S. Cl. CPC F16B 2/02
USPC 294/106

(57) ABSTRACT

A manhole tube holder can hold lengths of tubes secure while being extended with additional lengths of tubing. The manhole tube holder includes a clamp region that can hingedly move between open and closed positions. A locked position can cause the clamp region to secure tubing therein. A plurality of legs extends from the clamp region to rest on a rim of a manhole while tubing is extended down into the manhole. The legs can telescope to allow for easy storage and for adjusting to various sizes of manholes.

### CROSS-REFERENCE TO RELATED APPLICATION

This application claims the benefit of priority of U.S. provisional application number 61/635,657, filed Apr. 19, 2012, the contents of which are herein incorporated by reference.

### BACKGROUND OF THE INVENTION

The present invention relates to tube holders and, more particularly, to a tube holder providing a safety factor when working in manholes.

When vacuuming materials from a manhole, a crew often has a plurality of tubes that are attached to a boom of a vacuum truck to provide a tube of a sufficient length to reach the material in the manhole. However, when overhead power lines or trees are present, it can be difficult for the boom to raise the tubes high enough to be inserted into the manhole and reach the material therein.

Vacuum Tubes extending up in the air pose a safety and handling problem. Safety issues of touching electrical lines are the most dangerous and life threatening. Others issues include physical limitations, as the weight of 40 feet of tube can be over 130 pounds. Dropping or losing the vacuum tubes in a deep manhole requires retrieval and costly procedures for manhole entry. Tube assembly above ground is cumbersome and requires at least 3 workers, ropes or slings and much maneuvering.

As can be seen, there is a need for a method and apparatus that allows access to deep manholes or wet wells without the need to assemble tubes above ground and without the need for high boom lifts.

### SUMMARY OF THE INVENTION

In one aspect of the present invention, a manhole tube holder comprises a first clamp side; a second clamp side hingedly attached to the first clamp side; an inner section of the first clamp side and the second clamp side forming a retention surface for retaining a tube when the first clamp side and the second clamp side are in a closed configuration; a clamp pad disposed on at least a portion of the retention surface; a latching mechanism for securing the first clamp side to the second clamp side in the closed configuration; and a plurality of legs extending from the first clamp side and the second clamp side.

In another aspect of the present invention, a manhole tube holder comprises a first clamp side; a second clamp side hingedly attached to the first clamp side; an inner section of the first clamp side and the second clamp side forming a retention surface for retaining a tube when the first clamp side and the second clamp side are in a closed configuration; a clamp pad disposed on at least a portion of the retention surface; a male toggle latch on the first clamp side and a female toggle latch on the second clamp side, the male and female toggle latches securing the first clamp side to the second clamp side in the closed configuration; and a plurality of telescoping legs extending from the first clamp side and the second clamp side.

These and other features, aspects and advantages of the present invention will become better understood with reference to the following drawings, description and claims.

### BRIEF DESCRIPTION OF THE DRAWINGS

FIG. 1 is a perspective view of a manhole tube holder, in use, according to an exemplary embodiment of the present invention;

FIG. 2 is a perspective view of the manhole tube holder of FIG. 1 in an open configuration;

FIG. 3 is a detailed perspective view of a leg portion of the manhole tube holder of FIG. 1, illustrating telescoping legs; and

FIG. 4 is a top view of the manhole tube holder of FIG. 1, in a closed configuration, illustrating an open configuration by dashed lines.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a manhole tube holder that can hold lengths of tubes secure while being extended with additional lengths of tubing. The manhole tube holder includes a clamp region that can hingedly move between open and closed positions. A locked position can cause the clamp region to secure tubing therein. A plurality of legs extends from the clamp region to rest on a rim of a manhole while tubing is extended down into the manhole. The legs can telescope to allow for easy storage and for adjusting to various sizes of manholes.

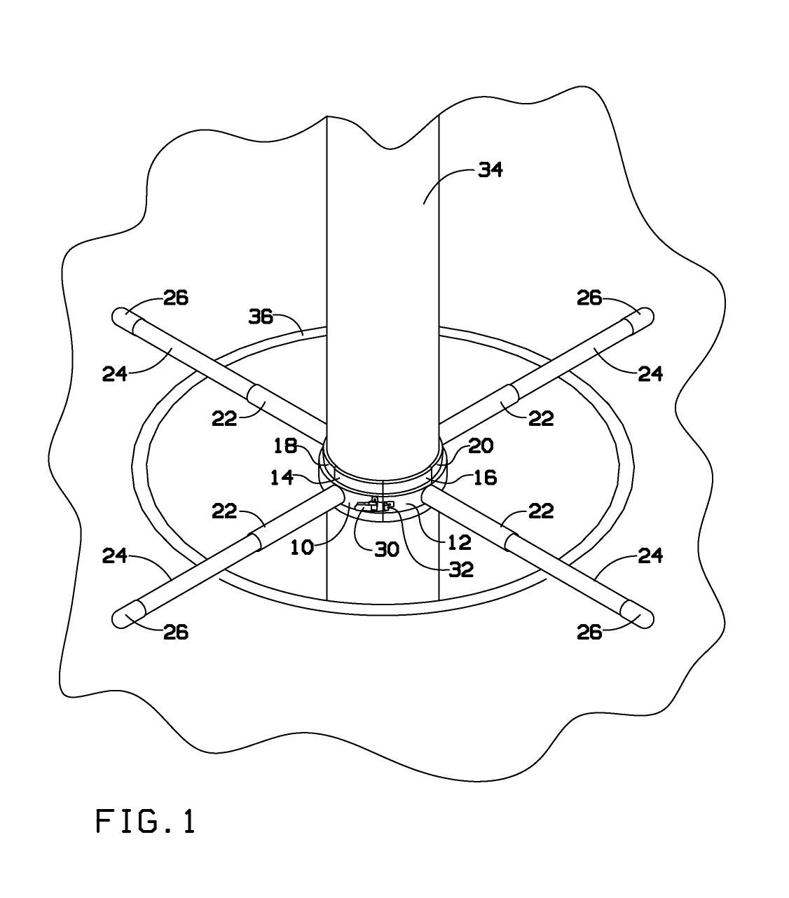

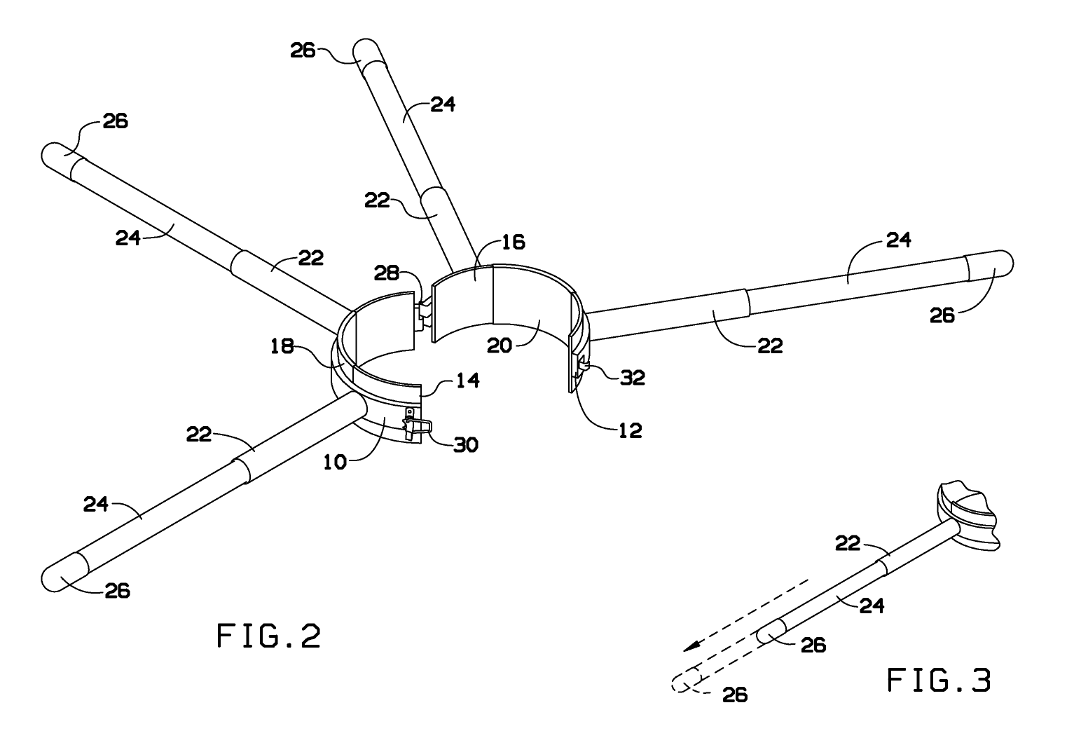

Referring now to FIGS. 1 through 4, a manhole tube holder can include a clamp main body formed from a first side 10 and a second side 12 attached together by a hinge 28. An inner surface 14, 16 of the first and second sides 10, 12, respectively, can have a clamp pad 18, 20 attached thereto.

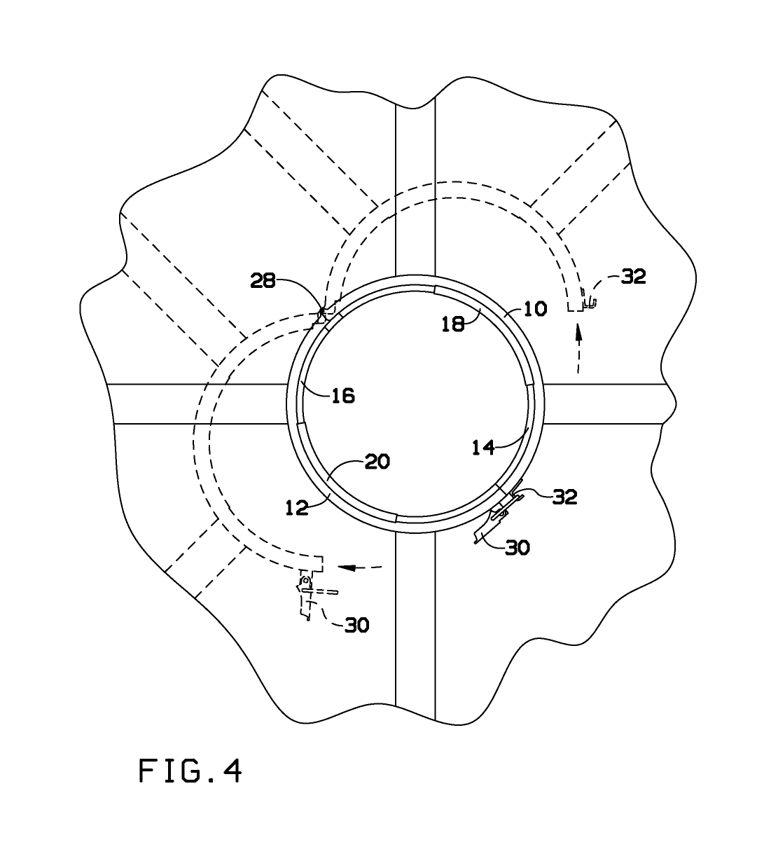

The first side 10 and the second side 12 can move between a closed position (solid lines in FIG. 4) and an open position (dashed lines of FIG. 4). In the closed position, a toggle latch male portion 30 can hook onto a toggle latch female portion 32 and the toggle latch male portion 30 can be moved to cause the inner surfaces 14, 16 to clamp against a suction tube 34. The toggle latch 30, 32 can be disconnected to remove the clamp main body from the suction tube 34.

A plurality of fixed rods 22 can extend from the first side 10 and the second side 12 of the clamp main body. Typically, two fixed rods 22 can extend from each side 10, 12. An extension rod 24 can telescope from each of the fixed rods 22. A rod cap 26 can be disposed on the end of each of the extension rods 24.

To use the manhole tube holder of the present invention, a user can simply clamp the tube holder around the tube 34. This can be done by closing the two sides 10, 12 around the tube 34 and locking the toggle latch 30, 32. The tube 34 can then be lowered down into the manhole 36. With the extension rods 24 extended the fixed rods 22 and extension rods 24 can keep the tube 34 from being lost into the manhole 36.

An additional tube can be added to the tube 34 while supported by the manhole tube holder, as shown in FIG. 1. The additional tube can be attached to a vacuum truck boom and easily attached to the tube 34 supported by the manhole tube holder. Once the additional tube is attached, the manhole tube holder can be disconnected from the tube 34, the two sections of tube can be lowered, with the manhole tube holder applied to the additional, added tube. The vacuum truck boom can be disconnected from the two sections of tube, now with both tubes supported by the manhole tube holder in the manhole, and a third length of tube can be connected to the vacuum truck boom and attached to the two-sections of tube. This process can be repeated until sufficient tube is added for the proper depth.

The manhole tube holder of the present invention can support up to or even more than about 50 feet of tube. The manhole tube holder can be used on manholes from about 24 to about 36 inches. Extensions for the legs can be used for larger manholes. The opening provided by the sides 10, 12 can be designed for various sizes of tubes, such as 6-inch tubes or 8-inch tubes.

It should be understood, of course, that the foregoing relates to exemplary embodiments of the invention and that modifications may be made without departing from the spirit and scope of the invention as set forth in the following claims.

What is claimed is:

1. A manhole tube holder comprising:
a first clamp side;
a second clamp side hingedly attached to the first clamp side;
an inner section of the first clamp side and the second clamp side forming a retention surface for retaining a tube when the first clamp side and the second clamp side are in a closed configuration;
a clamp pad disposed on at least a portion of the retention surface;
a latching mechanism for securing the first clamp side to the second clamp side in the closed configuration; and
a plurality of legs extending from the first clamp side and the second clamp side.

2. The manhole tube holder of claim 1, wherein two legs extend from the first clamp side and two legs extend from the second clamp side.

3. The manhole tube holder of claim 1, wherein the plurality of legs are telescoping legs having a fixed rod attached to the first and second clamp sides, and an extension rod telescopically attached to the fixed rod.

4. The manhole tube holder of claim 1, further comprising rod caps at the end of each of the plurality of legs.

5. The manhole tube holder of claim 1, wherein the latching mechanism includes a male toggle latch portion and a female toggle latch portion.

6. A manhole tube holder comprising:
a first clamp side;
a second clamp side hingedly attached to the first clamp side;
an inner section of the first clamp side and the second clamp side forming a retention surface for retaining a tube when the first clamp side and the second clamp side are in a closed configuration;
a clamp pad disposed on at least a portion of the retention surface;
a male toggle latch on the first clamp side and a female toggle latch on the second clamp side, the male and female toggle latches securing the first clamp side to the second clamp side in the closed configuration; and
a plurality of telescoping legs extending from the first clamp side and the second clamp side.

7. The manhole tube holder of claim 6, wherein two legs extend from the first clamp side and two legs extend from the second clamp side.

8. The manhole tube holder of claim 6, further comprising rod caps at the end of each of the plurality of legs.
